(19) United States
(12) Patent Application Publication
(10) Pub. No.: US 2006/0056203 A1
(43) Pub. Date: Mar. 16, 2006

(54) LED luminance enhancing construction

(75) Inventors: Ming-Shun Lee, Taipei (TW); Ping-Ru Sung, Taipei (TW)

Correspondence Address: TROXELL LAW OFFICE PLLC, SUITE 1404, 5205 LEESBURG PIKE, FALLS CHURCH, VA, 22041, US

(73) Assignee: Taiwan Oasis Technology Co., Ltd.

(21) Appl. No.: 10/937,624

(22) Filed: Sep. 10, 2004

(51) Int. Cl. F21S 4/00

(52) U.S. Cl. 362/800; 362/555; 362/543; 362/545; 362/227; 362/236; 362/244

(57) ABSTRACT

A construction to enhance luminance of a light emitting diode having a plate luminance-enhancing device provided on the surface of electric circuit of the LED; a recess to permit penetration by the LED, wall of the recess facing the reflective wall expanding at a certain inclination in the direction of the dome of the LED to reflect the light source at the position of the peripheral of the LED in the direction of towards the dome of the LED to significantly upgrade the luminance performance of the LED.

### BACKGROUND OF THE INVENTION

(a) Field of the Invention

The present invention is related to a luminance-enhancing construction for a light emitting diode (LED), and more particularly, to one that effectively enhances the LED luminance by having the LED installed in a recess of the luminance-enhancing device without changing the structure of the body of the LED.

(b) Description of the Prior Art

As illustrated in FIG. 1 for a schematic view showing a construction of an LED of the prior art, the LED 10 relates to a transparent package 11 containing multiple conductors 12 of different polarities and a carrier 13; a chip 14 is fixed to the carrier 13, and a golden plated wire 15 connects an electrode layer of the chip 14 and those conductors 12 while each conductor 12 extending out of the transparent package 11 to become a pin for the LED 10 to connect to related electric circuit.

Therefore, once the electric circuit conducts the conductor 12, the conductor emits light through a light source created by the chip 14. Alternatively, fluorescent material (not illustrated) may be provided in the peripheral to the chip 14 so that when the light source produced by the chip 14 penetrates the fluorescent material, at the moment that the wavelength of the fluorescent is incorporated with that from the light source to become the light color expected. However, the conductor 12 is provided with two pins and a comparatively gap exists between both pins, and the size of the transparent package is comparatively larger, certain portions of the light penetrates through the side at the base of the LED and get wasted when the LED is lighted.

It can be expected that given with the ever improving process and manufacturing technology related to the LED, the size of the market for the LED will fast expand. However, as far as the present art is concerned, LED related technology R&D efforts still address the performance of the LED light color and how to upgrade LED production capacity; on the contract, technical breakthrough is seldom seen on improved LED luminance.

### SUMMARY OF THE INVENTION

The primary purpose of the present invention is to provide a construction for enhancing the luminance of a light emitting diode. To achieve the purpose, a luminance-enhancing device is provided on the surface of the electric circuit of the LED. The luminance-enhancing relates to a plate structure provided with a recess for penetration by the LED with the wall in the recess facing the reflective wall expanding at a certain inclination in the direction of the dome of the LED so that the light source from the position of the peripheral to the LED reflects in the direction of the dome of the LED to significantly upgrade the luminance performance of the LED.

### BRIEF DESCRIPTION OF THE DRAWINGS

FIG. 1 is a schematic view showing a construction of a light emitting diode of a first preferred embodiment of the present invention.

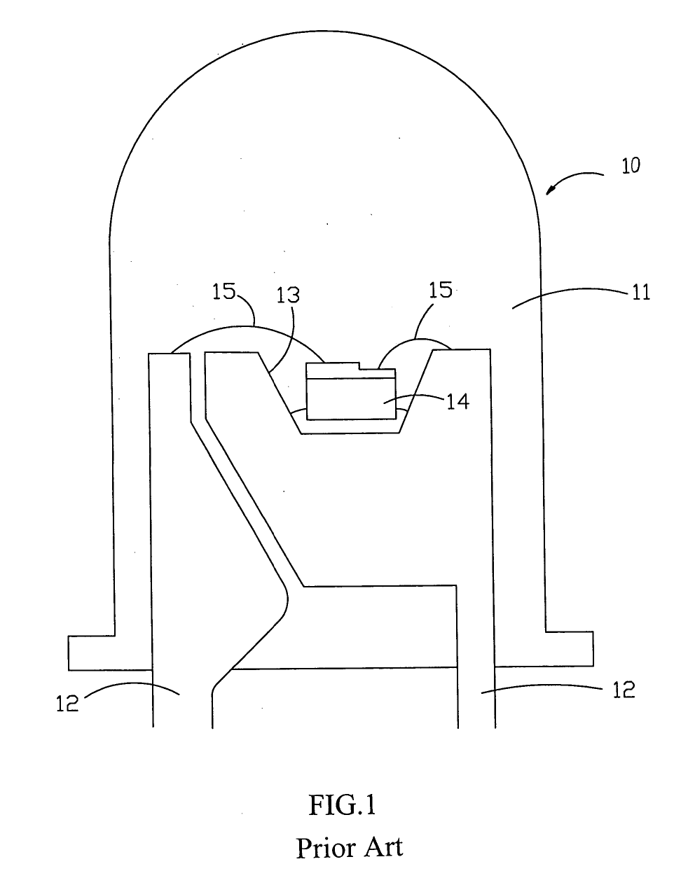

FIG. 2 is a sectional view of a construction of a luminance-enhancing device of the preferred embodiment of the present invention.

FIG. 3 is a schematic view showing the assembly of the LED in the preferred embodiment of the present invention.

FIG. 4 is a schematic view showing the light reflection pattern of the luminance-enhancing construction of the preferred embodiment of the present invention.

### DETAILED DESCRIPTION OF THE PREFERRED EMBODIMENTS

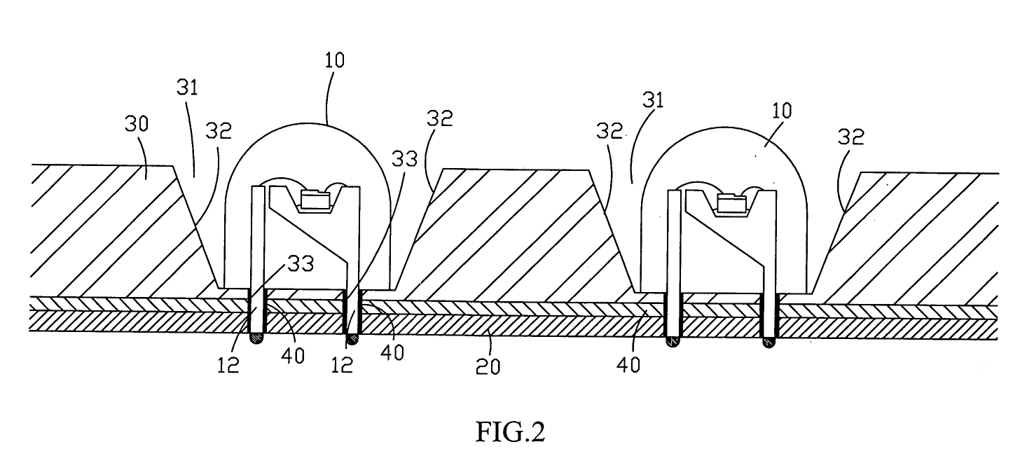

Referring to FIG. 2 for a basic configuration of a luminance-enhancing construction for an LED, a luminance-enhancing device 30 is provided on a surface 20 of an electric circuit of the LED 10. Wherein, the light-enhancing device 30 relates to a plate structure and is provided with a recess 31 for the LED 10 to penetrate into and the wall in the recess is facing a reflective wall 32 expanding at a certain inclination in the direction of the dome of the LED 10.

In a preferred embodiment of the present invention, the luminance-enhancing device 30 is directly made of a metal clad copper plate (or aluminum-based clad copper plate) so to give the reflective wall 32 in the recess 31 the effects of reflecting the light source. The LED 10 does not penetrate through the base of the recess 31, instead, two or multiple through holes 33 are provided on the base of the recess 31 and a thin sheet insulator 40 is disposed between the light-enhancing device 30 and the electric circuit 20.

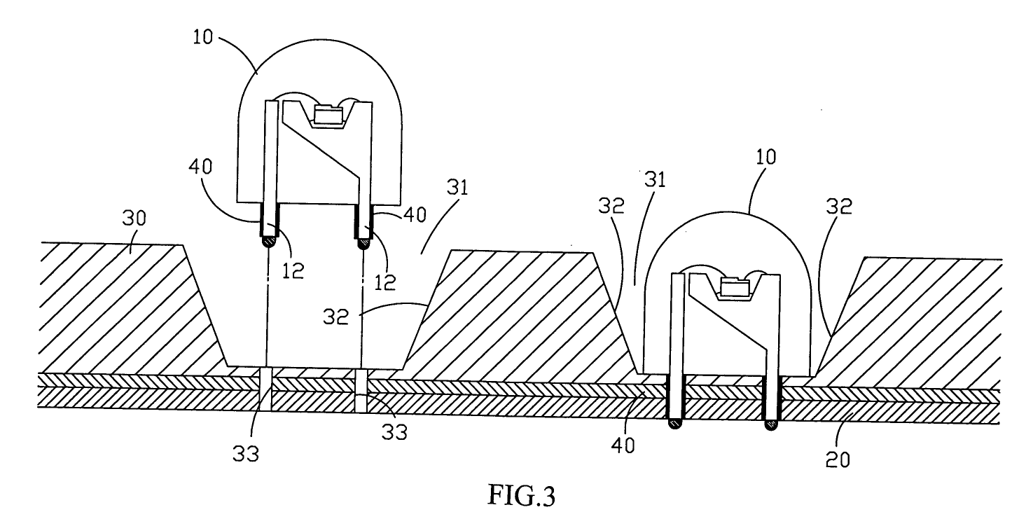

As illustrated in FIG. 3, the conductor 12 of the LED 10 connects to the circuit on the lower surface of the electric circuit 20 through multiple through holes 33 of the luminance-enhancing device 30, and on the inner circle of the through hole 33, i.e., at where between each conductor and the through hole 33, is disposed with a ring shaped insulator 40 to prevent from short circuit to the LED 10 by the luminance-enhancing device 30.

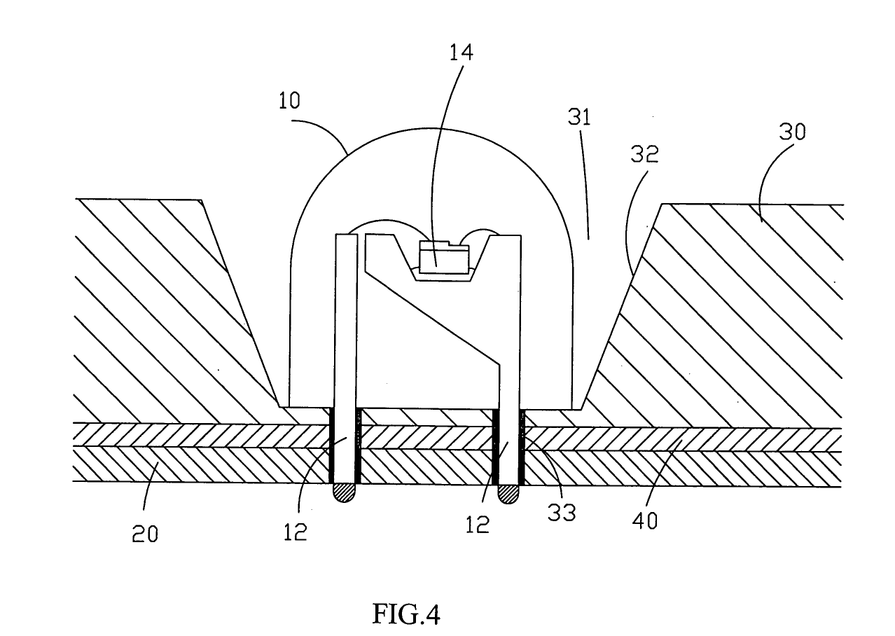

Once the conductor 12 of the LED is conducted by the electric circuit 20 to cause the chip 14 to produce light emission results as illustrated in FIG. 4, the light source from the peripheral position of the LED 10 is deflected in the direction towards the dome of the LED 10 through the reflective wall 32 in the recess 31 of the luminance-enhancing device 30 to significantly upgrade the luminance performance of the LED.

As disclosed above, the present invention of a luminance-enhancing construction by effectively improving the luminance performance results of an LED without changing the structure of the body of the LED provides significant improvement of the function of the LED; therefore, this application for a utility patent is duly filed. However, it is to be noted that that those preferred embodiments disclosed in the specification and the accompanying drawings are not limiting the present invention. Therefore, any construction, installation, or characteristics that is same or similar to that of the present invention should fall within the scope of the purposes and claims of the present invention.

I Claim,

1. An LED luminance-enhancing construction includes a luminance-enhancing device provided on the surface of an electric circuit of the LED; the luminance-enhancing device is related to a plate structure and provided with a recess to permit penetration by the LED; and the wall in the recess is facing a reflective wall expanding at a certain inclination in the direction of the dome of the LED.

2. The LED luminance-enhancing construction of claim 1, wherein, two through holes as a minimum are provided on the base of the recess of the luminance-enhancing device, and the conductor of the LED penetrates into the through hole to connect to the electric circuit.

3. The LED luminance-enhancing construction of claim 1, wherein, the luminance-enhancing device is comprised of a metal clad plate, and an insulator is disposed between the luminance-enhancing device and the electric circuit.

4. The LED luminance-enhancing construction of claim 1, wherein, the luminance-enhancing device is comprised of a metal clad plate, two through holes as a minimum are provided on the base of the recess, an insulator being provided at where between each conductor of the LED and the through hole; and another insulator is disposed between the luminance-enhancing device and the electric circuit.
